(19) United States
(12) Patent Application Publication
(10) Pub. No.: US 2011/0161152 A1
(43) Pub. Date: Jun. 30, 2011

(54) METHOD AND APPARATUS FOR PRINTING ON DEMAND COUPONS TRIGGERED BY A TEXT MESSAGE

(76) Inventors: Eric Kash, Roslyn Heights, NY (US); David Foni, Englewood, NJ (US)

(21) Appl. No.: 12/954,462

(22) Filed: Nov. 24, 2010

Related U.S. Application Data
(60) Provisional application No. 61/283,036, filed on Nov. 24, 2009.

(51) Int. Cl. G06Q 30/00

(52) U.S. Cl. 705/14.25; 705/14.1

(57) ABSTRACT

An apparatus and related method for on-demand coupon printing of offers/coupons received as a user text message comprising: a LCD screen for advertising products or services with discounted offers/coupons; wherein the offers/coupons include a code or text number; a means for receiving the code or text number from a user as a user text message to request the offers/coupons displayed on the screen; a database for identifying the user by checking the users cell phone number or an assigned identification code to determine if user is an existing user or a new user in the database; a means for sending an apparatus text message to the users cell phone requiring the user to acknowledge receipt of the apparatus text message; a means for accepting the acknowledgement and sending a coupon text message to users cell phone including the offers/coupons to the user; a touch screen for offer/coupon display and to enable the user to enter their cell phone number or identification code; and a printer to print said coupon text message sent to users cell phone.

This application claims the benefit of U.S. provisional application No. 61/283,036 filed Nov. 25, 2009, which is incorporated herein in its entirety by reference.

### FIELD OF THE INVENTION

The present invention relates to an apparatus and related method for on-demand coupon printing of offers received as a text message. In particular, the text message prompts the receiver to visit the apparatus at a specific location to print the coupon offer.

### BACKGROUND OF THE INVENTION

The new digital networks and the common use of cellular telephones have created new marketing tools and one of them is delivering information via a text message. As a form of communication, text messaging is a way that many individuals and demographics prefer to communicate.

Text Messaging is regulated by the Government and prohibits unsolicited messages. It has a tremendous benefit and cost performance, that provides an incentive to an entity that can access the user via this tool. Consumers/Recipients must “opt-in” or allow the sender to send text messages. The Sender must also provide the Recipients with the ability to “Opt-Out” of receiving Text Messages from the Sender.

The ability to send, targeted, messages is an enormous advantage to a Sender/Advertiser as the message is expected to generate a better response than an unsolicited message at very little to no cost. The sender can continue to send additional messages to recipient on a continual basis until the recipient requests a termination of the cell messages, also known as “Opting-Out”.

Each offering displayed on the invention kiosk is in a format of static, animated, video with an optional an audio component. The user will have the ability to identify and select a specific offering(s) that has been texted to them. In addition the user can request additional information on the discount coupon.

After a ‘Double Opt-In’, which is the User sending a Short Code to a Text number (First Opt-In) and then sending another text message in response to the Sender confirming the Users request to Opt-In (Second Opt-In) will complete the User's enrollment into the system. The user will become a member of a specific location's community and thus can be sent additional offerings to him individually and/or their specific community.

The user can redeem the offerings for discount at the location designated on the coupon by purchasing the items promoted. The sender can choose to send to all text message members, segregated by zip code or street address, members of specific groups or target specific individuals.

The use of a text message on a cellular telephone to redeem coupons is very cumbersome and not user friendly. The user can procure their coupon by printing it from the Kiosk. Authentication of the User can be done by entering their cell phone number and/or an ID provided by the system in the text message that the User received.

The use of the paper coupon (printed coupon) enables the retailer to follow typical processes of coupon redemption.

An object of the invention is to provide the means of reaching out to targeted groups of cellular telephone users via text messages and providing them with discount coupons, which can be printed at an invention apparatus, preferably a kiosk.

A further object of the invention is to group cell phone users so that they may be targeted and marketed to as a Community. A Community is a collection of people that are grouped by a location (i.e. a specific supermarket or department store, by location, occupation etc.).

A further object of the invention is to allow a cell phone user an easy and convenient way of obtaining coupons. The users can print the chosen coupons at the kiosk located in the establishment.

A further objective of the invention is to identify the purchasing habits of users interested in specific offerings and use the data to create predictive algorithms to solicit the purchasers for future offerings.

### SUMMARY OF THE INVENTION

In the present invention, these purposes, as well as others which will be apparent, are achieved generally by providing an apparatus for on-demand coupon printing of offers/coupons received as a text message comprising: a screen for advertising products or services with discounted offers/coupons; wherein said offers/coupons include a code or text number; a means for receiving the text message code from a user; a means for identifying said user by checking the users cell phone against a database; wherein if the user is an existing user the information requested will be sent via text message and if the user is a new customer they are added to the database prior to receiving any text messages; a means for allowing the user acknowledge and accept receipt of text messages with marketing offers; a means to send said text messages to the acknowledged user's cell phone; and a means for said user to print said offers/coupons on the apparatus.

The invention also includes a method for on-demand coupon printing of offers/coupons received as a text message comprising: the apparatus as defined above, that generates an offer/coupon which is sent to users cell phones or PDA via a text message; receiving the text message; wherein the user either acknowledges receipt or denies receipt of said text message. Acknowledging receipt of said text message permits delivery of the text message and provides user means to access the apparatus for printing and redemption; denying receipt of said text message permits deletion of the message and provides the system to reset.

Other objects, features and advantages of the present invention will be apparent when the detailed description of the preferred embodiments of the invention are considered with reference to the drawings, which should be construed in an illustrative and not limiting sense.

### BRIEF DESCRIPTION OF THE DRAWINGS

FIG. 1 is a flow chart of the apparatus components of the invention; and

FIG. 2 is a flow chart of the system logic of the invention.

### DETAILED DESCRIPTION OF THE INVENTION

In accordance with the present invention a system is provided for on-demand coupon printing for offers received as a text message. The user is enrolled into a savings based text message program to receive these special messages. A user is sent a text message offering which prompts the receiver to visit a kiosk to print coupons specific to the program. Coupons can be unique to the venue and time sensitive. (i.e. Today Only).

The system is composed of a stand alone kiosk or can be integrated into an existing financial services kiosk that communicates with the user and the main system to provide on demand coupons from a request made by the user after he responded or initiated the request via a text message.

An additional, integrated, component of this system is advertising. This service is provided through the installation of an additional screen mounted above or in close proximity to the kiosk. This provides additional, capabilities to, communicate with potential customers for various purposes.

The user is able to print physical coupons, on demand, by entering his or her telephone number or another ID provided when he or she responds to the text message or initiates the request by sending a text message for the desired offering.

The offered coupons have a bar code that triggers the discount at the point of sales (POS) in the particular location where the coupon was printed.

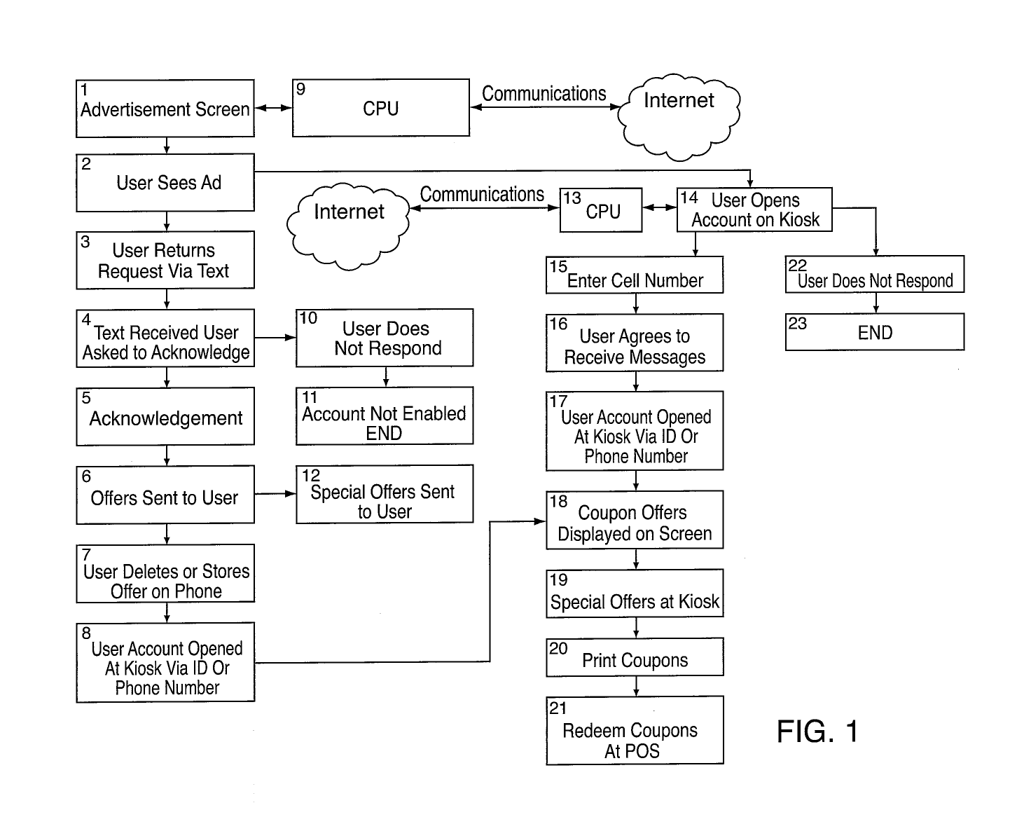

The general method of the invention is illustrated in FIG. 1 and is described in more detail below.

1—Advertisement Screen. The advertisement screen provides numerous advertisements as part a digital network. A schedule of advertisements and other content will provide information regarding products or services with discounted offers/coupons. The advertisements provided via the Screen can be slides, pictures, videos, animations all with sound or without it.

The Advertisement Screen can be a flat screen monitor integrated or placed near the invention apparatus, or kiosk.

Each advertisement includes a Quick-Dial text number and Short Code that is used by the consumer to request information. Alternatively, or in addition to, a web site that the customer can access and request more information and/or register to receive text message alerts may also be included.

2—User Sees the Ad. The invention apparatus/kiosk is placed in retail location such as, supermarkets, department stores, casinos and malls etc. Users passing by will see the Advertisement Screen 1 and the various offerings for the products featured.

3—User Returns Request via Text. If a customer is interested in getting more information on the offer shown on the Screen or wants to gain access to all offers they can request access by texting a Short Code to a Text Number which is shown in the advertisement.

4—Text Received: User Required to Acknowledge. The text message received by the system uses the cell number the Text Message was sent from to identify the user/customer. It is checked against the database. If this is an existing customer then the information requested will be sent. If this is a new customer then they must be added to the database prior to receiving any messages. This process requires a Double “Opt-In” and once the process is complete the User is now part of a Community and will begin receiving Offers via Text Messaging.

5—Acknowledgement. If the user/customer acknowledges his request for information and his interest to receive further information, from the particular establishment, an account will be opened and he will be assigned on ID in addition of being recognized by the cell number.

6—Offers Sent to Users. The information requested, regarding the specific offering, is being sent to the user/customer and his account information as well.

7—User Deletes or Stores Offer on Phone. The user/customer will receive the various text messages with the marketing offers from the establishment and he has the ability to delete them or store them on his cell phone in order to use the discount coupon at the time of purchase.

8—User Account Opened at Kiosk via ID or Phone number. When the user/customer accesses the kiosk on the establishment premises hr has to enter his cell number or assigned ID in order to print the coupons for the various offerings sent to his cell phone.

9—CPU. The CPU (pc, computer) located inside the physical kiosk communicates with the main servers located of premises and with the Advertisement Screen 1 on the kiosk. The CPU 1 stores all relevant information for displaying the advertisements according to the preset schedule and communicates with the server to receive updates and new information to be displayed. Communication can be accomplished via the WEB or via a dedicated network.

10—User Does Not Respond. If the user does not respond to the text message sent and received in item 4 his/her account is not enabled.

11—Account Not Enabled—End. The data entry into the data base will be deleted.

12—Special Offers Sent to User. At this point, after the user/customer acknowledges, “Opts-In” in item 6, his/her willingness to receive text messages with marketing offers from the establishment, various offers and specials will be provided as they are available. They will be sent as text messages to his/her cell phone.

13—Second CPU. A second CPU (PC, Computer) can be incorporated or the CPU depicted in item 9 can be used to control and manage the operation of the physical apparatus/kiosk. This CPU will communicate with the servers in real time and provide to the system the control and information needed to operate. It manages and controls all components in the Kiosk such as Touch Screen, Coupon Printer, Bar Code Reader, Dispensers and all required other devices.

14—User Opens Account on Kiosk. The user/customer that views the offerings on the Advertisement Screen 1 can open an account to receive the offering via text messages on his cell phone at the kiosk in person. He will be asked to enter his cell number, by using the Touch Screen.

15—User Enters Cell Number. The user/customer enters his cell phone number.

16—User Agrees to Receive Messages. At this time the user/customer will be asked to acknowledge that he is accepting that the particular establishment will send them various marketing offers via their cell phone using the text messaging as the delivery medium.

17—User Account Opened at Kiosk via ID or Phone Number. A user account is opened in the system and the user/person can use and ID or their cell number to access the system.

18—Coupon Offers Displayed on Screen. Various offers relevant to the text message requested or existing offers are being displayed on the screen for the user.

19—Special Offers at Kiosk—In addition to the texted offers the system has the ability to display/provide the specific user/customer with special offers at the kiosk. The offers can be determined according to the users purchasing habits or by the temperature outside at the time of the offer or by any other criteria set up by the establishment.

20—Print coupons. After choosing the specific coupons, by the user/customer, they are printed at the kiosk.

21—Redeem coupons at POS. The user/customer can redeem the coupons by purchasing/using the products offered in order to receive the discounts. The redemption is done at the point of sale (POS) terminal in the store. Each coupon has its unique bar code printed on that identifies the offers as advertized by the system.

22—User Does Not Respond. If the user/customer does not respond with his cell number an account will not be opened.

23—End. The kiosk will present the user/customer with other functions available by displaying them on the touch screen.

As illustrated in FIG. 1, there are two ways that the user can open an account. The first is for the user to physically open an account at the Kiosk, in person, not using the cell phone. See specifically, item 14. Items 14 to 17 depict the opening of an account and agreement to receive text messages at the kiosk without using the cell phone.

The second method to open an account is using a cell phone. Items 3-8 depict how the user can open an account using their cell phone. He or she would use the texting, or double opt in to open an account.

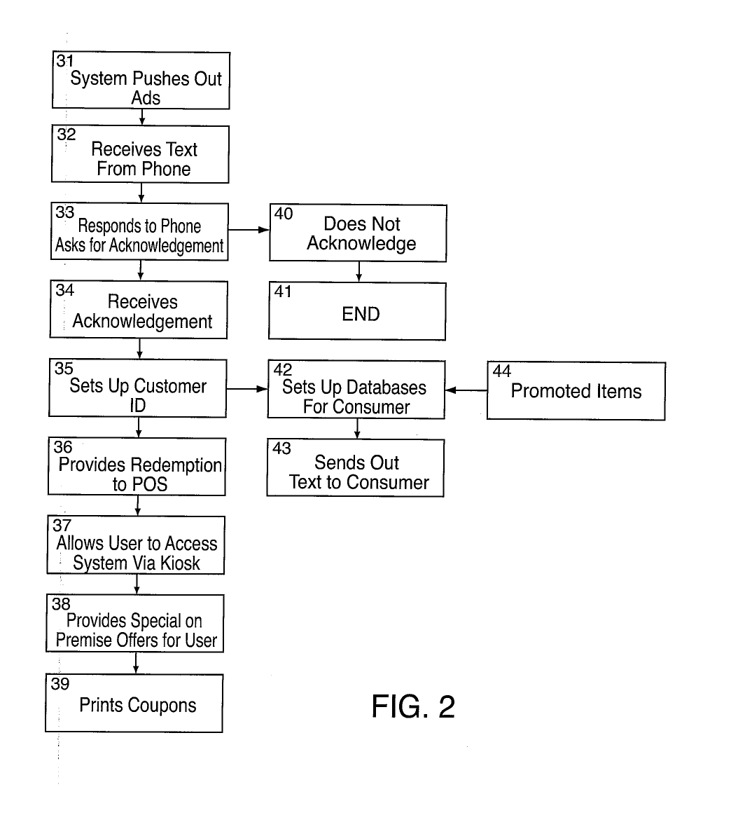

While FIG. 1 depicts the physical events that are taking place in the invention process and the sequence to enroll into the system, FIG. 2 depicts a flow chart of the system logic processes of the invention and is described in more detail below.

31—System pushes our Ads. The system is designed to distribute advertisements and offers based on the location of the Kiosk. The system manages all aspects of scheduling and tracking what information is displayed for each Location.

32—Receives Text From Phone. The system receives text messages from cell phones and identifies them as to the location and content. The system will also determine if the person/customer is already registered in the system or not.

33—Responds to Phone: Asks for Acknowledgement. If the system determines that it is a new user it will send an additional text message to the user asking for acknowledgment to accept text messages from the particular establishment, Double “Opt-in”.

34—Receives Acknowledgment. If the system receives the Double “Opt-in” an account is created.

35—Sets Up Customer ID. Once the user account is created the system can send text messages, to this user or to the Community in which the User belongs, with marketing offerings. User accounts are accessed at the Kiosk using Cell Phone Numbers and Access Codes.

36—Provides Redemption to POS. The system provides information to the POS software for redemption purposes. The system sends pertinent information regarding the offerings, discount levels, required triggers to receive discounts, and acquires information from the POS system regarding coupons redeemed.

37—Allows User to Access System via Kiosk. The system creates an account for the person/customer and provides access to coupons/offers at the physical location.

Each physical location will display offers/coupons and advertisements. Each Location will be assigned a unique Short Code. This Short Code is also associated to a Community Name. It also will provide the user/customer access all offers assigned to a location.

For example it will let a user access all kiosk placements in “ABC” supermarket chain even if the initial text was from “ABC-1” store. The user will receive text message relevant to the “ABC-1” store but will be able to access and print offers/coupons in all “ABC” stores.

38—Provides Special n Premise offers for User. The system is able to provide unique offerings to specific users, recognizing them from their ID, as to specific location.

The offerings can be targeted according to demographics, pre-determined purchasing habits, local market temperatures, time of day, habits and any other categories determined by Company.

39—Coupons. The system prints out the chosen coupons/offers by the user/customer at the specific kiosk.

40—Does Not Acknowledge. If the text message is not acknowledged within a pre-determined period of time, the system will delete the information from the database.

41—End. The database record is deleted and reset.

42—Sets up Databases for Consumer. The system processes data for consumers according to the specific location where they were viewed by the user/customer.

43—Sends out Text to Consumer. The system sends out text messages to user/customer according to the cell number and physical location that they register at, Community Membership.

44—Promoted Items. Promoted items are marketed to specific users according to Community Membership and any additional marketing criteria decided by the establishment.

The apparatus used in the present invention is described in more detail in the utility application filed simultaneously with this application entitled Method and Apparatus for Dispensing On Demand Coupons based on provisional patent application Ser. No. 61/283,029, incorporated herein in its entirety by reference. In general the steps above illustrate the apparatus for on-demand coupon printing of offers/coupons received as a user text message comprising a LCD screen for advertising products or services with discounted offers/coupons; wherein the offers/coupons include a code or text number; a means for receiving said code or text number from a user as a user text message to request the offers/coupons displayed on the screen; a database for identifying said user by checking the users cell phone number or an assigned identification code to determine if user is an existing user or a new user in the database; a means for sending an apparatus text message to the users cell phone requiring the user to acknowledge receipt of the apparatus text message; a means for accepting the acknowledgement and sending a coupon text message to users cell phone including the offers/coupons to the user; a touch screen for offer/coupon display and to enable the user to enter their cell phone number or identification code; and a printer to print the coupon text message sent to users cell phone.

The apparatus according to the invention includes a controller unit connected to a network for controlling all internal and external communication to and from the apparatus including a means for providing real time reporting of the coupons dispensed and redeemed.

The controller unit includes an advertisement processer for displaying advertisements on the LCD screen and a separate transaction processor for completing the desired transaction by the user.

The apparatus also includes a bill acceptor, a card scanner, a card dispenser, a bar code scanner and a magnetic strip reader.

The method for on-demand coupon printing of offers/coupons received as a user text message includes the apparatus as defined above that generates an offer/coupon selected by a user and sent to the user's cell phone or PDA via text message for printing at the apparatus and redemption at a particular location.

More specifically, the method includes receiving the user text message requesting an offer/coupon advertised on the LCD screen; entering the data relating to the user text message request into a database; sending an apparatus text message to the user in response to the request; wherein the user either acknowledges receipt or denies receipt of the apparatus text message; acknowledging receipt of the apparatus text message by the user and delivery of an offer/coupon text message to provide the user means to access the apparatus for on-demand printing and redemption of the offer/coupon.

The data relating to the user text message request in the database when the user denies receipt of said apparatus text message is deleted from the database.

The method also identifying the user by checking the database using the users cell phone number or an assigned identification code to determine if user is an existing user or a new user in the database. A new user must be added to the database prior to receiving any apparatus text messages.

The apparatus has the ability to read credit, debit and/or loyalty cards of a user with a magnetic strip and provides the users information and behavior data to the database.

The apparatus has the ability to read loyalty cards to identify the user at the apparatus and provide information to the database to provide user with special coupon offers according to their shopping history.

The apparatus is in communication with a data warehouse outside the apparatus that stores specific user data and provides behavioral analytics to provide the user with special coupon offers at a particular location according to their shopping history. The offers/coupons are targeted to the user according to demographics, pre-determined purchasing habits, local market temperatures, time of day, local consumer tastes and habits.

User data in the database is processed according to the specific location where the offers/coupons were viewed by the users. Promotional items are marketed on the apparatus to specific users according to the data in said database.

For example, as customers select coupons and offers on the apparatus, they are coupled to the customer's card number and injected directly into the locations existing point of sale. As customers items are scanned, e-coupons and discounts are applied in real-time during checkout. Coupons are automatically validated and sent to the sponsoring manufacturer for reimbursement.

Apparatus content can be programmed individually to provide targeted messaging and couponing based on customer behavioral analysis as well as specific store metrics.

The apparatus provides the ability to process coupons and provide loyalty enrollment cards for a loyalty program designed for specific stores. They also provide consumers with information and functionality needed to redeem coupons for obtaining immediate discounts in store. The digital signage screens attached to the apparatus provide advertising opportunities for both national and local advertisers.

The apparatus according to the invention are preferably located in supermarkets and display promoted products on the digital screen as well as providing the ability to redeem coupons in order to purchase at a discounted rate. The invention system tracks the number of dispensed coupons as well as calculates the rebates that the store is due. The upper screen on the apparatus is used as a tool to advertise store promotions and has an interface allowing the local store to display and show special promotions. It receives its information from central servers that distributes the data to specific locations as required.

The loyalty enrollment program and dispensing of loyalty cards is designed to automate the manual function proved by the store employees and allow the system to gather information on specific purchase trends.

The apparatus of the invention provides in-store product advertising and on-demand coupons. The in-store coupons have a redemption rate of nearly 30%, compared to a rate of 1.4% for traditional coupon mediums.

A preferred apparatus has a 32 inch advertisement screen, a 15 inch touch screen interface, an 80 mm thermal coupon printer, a CCD bar code reader, a loyalty card dispenser, a dual mag-stripe card reader. The apparatus is capable of multiple languages and is designed to work in conjunction with existing ATM placements.

The foregoing description of various and preferred embodiments of the present invention has been provided for purposes of illustration only, and it is understood that numerous modifications, variations and alterations may be made without departing from the scope and spirit of the invention as set forth in the following claims.

What is claimed is:

1. An apparatus for on-demand coupon printing of offers/coupons received as a user text message comprising:
a LCD screen for advertising products or services with discounted offers/coupons; wherein said offers/coupons include a code or text number;
a means for receiving said code or text number from a user as a user text message to request said offers/coupons displayed on said screen;
a database for identifying said user by checking the users cell phone number or an assigned identification code to determine if user is an existing user or a new user in the database;
a means for sending an apparatus text message to said users cell phone requiring the user to acknowledge receipt of said apparatus text message;
a means for accepting said acknowledgement and sending a coupon text message to users cell phone including said offers/coupons to the user;
a touch screen for offer/coupon display and to enable the user to enter their cell phone number or identification code; and
a printer to print said coupon text message sent to users cell phone.

2. The apparatus according to claim 1, further comprising a controller unit connected to a network for controlling all internal and external communication to and from the apparatus including a means for providing real time reporting of the coupons dispensed and redeemed.

3. The apparatus according to claim 2, wherein said controller unit comprises an advertisement processer for displaying advertisements on said LCD screen.

4. The apparatus according to claim 2, wherein said controller unit comprises a transaction processor for completing the desired transaction by the user.

5. The apparatus according to claim 1, further comprising a bill acceptor.

6. The apparatus according to claim 1, further comprising a card scanner.

7. The apparatus according to claim 1, further comprising a card dispenser.

8. The apparatus according to claim 1, further comprising a bar code scanner.

9. The apparatus according to claim 1, further comprising a magnetic strip reader.

10. A method for on-demand coupon printing of offers/coupons received as a user text message comprising the apparatus as defined in claim 1 that generates an offer/coupon selected by a user and sent to the user's cell phone or PDA via text message for printing at the apparatus and redemption at a particular location.

11. The method according to claim 10, comprising:
receiving the user text message requesting an offer/coupon advertised on the LCD screen;
entering the data relating to the user text message request into a database;
sending an apparatus text message to the user in response to the request;
wherein the user either acknowledges receipt or denies receipt of said apparatus text message;
acknowledging receipt of said apparatus text message by the user and delivery of an offer/coupon text message to provide the user means to access the apparatus for on-demand printing and redemption of the offer/coupon.

12. The method according to claim 11, further comprising deleting the data relating to the user text message request in the database when the user denies receipt of said apparatus text message.

13. The method according to claim 11, further comprising identifying the user by checking the database using the users cell phone number or an assigned identification code to determine if user is an existing user or a new user in the database.

14. The method according to claim 13, wherein a new user is added to the database prior to receiving any apparatus text messages.

15. The method according to claim 11, further comprising reading credit, debit and/or loyalty cards of a user with a magnetic strip to provide the users information and behavior data to said database.

16. The method according to claim 11, further comprising reading loyalty cards to identify the user at the apparatus and provide information to said database to provide user with special coupon offers according to their shopping history.

17. The method according to claim 10, wherein the apparatus is in communication with a data warehouse outside the apparatus that stores specific user data and provides behavioral analytics to provide the user with special coupon offers at a particular location according to their shopping history.

18. The method according to claim 10, wherein the offers/coupons are targeted according to demographics, pre-determined purchasing habits, local market temperatures, time of day, local consumer tastes and habits.

19. The method according to claim 11, further comprising processing user data in said database according to the specific location where the offers/coupons were viewed by the users.

20. The method according to claim 11, wherein promotional items are marketed to specific users according to the data in said database.
